(19) United States
(12) Patent Application Publication
(10) Pub. No.: US 2014/0288957 A1
(43) Pub. Date: Sep. 25, 2014

(54) PRICE TRANSPARENCY SEARCH AND BUNDLING FOR SURGERIES AND MEDICAL PROCEDURES AND SERVICES

(71) Applicants: Marc Alan Grossman, Anaheim Hills, CA (US); Dante Michael Panella, Odessa, FL (US)

(72) Inventors: Marc Alan Grossman, Anaheim Hills, CA (US); Dante Michael Panella, Odessa, FL (US)

(21) Appl. No.: 14/296,198

(22) Filed: Jun. 4, 2014

Related U.S. Application Data
(60) Provisional application No. 61/876,622, filed on Sep. 11, 2013.
(60) Provisional application No. 61/631,585, filed on Jan. 9, 2012.

(51) Int. Cl. G06Q 50/22; G06Q 30/02

(52) U.S. Cl. CPC G06Q 50/22; G06Q 30/0283
USPC 705/2

(57) ABSTRACT

A system or method for providing price transparency for surgeries, medical procedures, and medical services. The system or method allows a user to search by desired attributes (e.g., cost, procedure, location, etc.) to obtain previously unpublished pricing information for medical care. The user may choose medical care at a desired location based upon the provided data and schedule an appointment for such medical care. The system or method may be financed by revenue from advertisements displayed to the user, membership fees for participating health care facilities or professionals, or search fees or click-through fees when a patient schedules or obtains treatment at a facility participating in the system or method. Bundled packages of surgeries, medical procedures, and medical or ancillary services may be offered to the user.

### CROSS REFERENCE TO RELATED APPLICATIONS

This application claims the benefit of U.S. Provisional Patent Application Ser. No. 61/876,622, filed on Sep. 11, 2013, entitled “PRICE TRANSPARENCY SEARCH AND BUNDLING FOR SURGERIES AND MEDICAL PROCEDURES AND SERVICES,” which is hereby incorporated by reference in its entirety. This application also claims the benefit of U.S. Provisional Patent Application Ser. No. 61/831,585, filed on Jun. 5, 2013, entitled “PRICE TRANSPARENCY SEARCH FOR SURGERIES AND MEDICAL PROCEDURES AND SERVICES,” which is hereby incorporated by reference in its entirety.

### BACKGROUND

1. Field of the Invention

The present invention relates to a method and system for aiding a user in obtaining desired medical procedures. More particularly, the present invention relates to a method and system for locating, choosing and booking medical procedures and services via a central server or computerized network based upon parameters input or identified by a user.

2. Description of the Related Art

As health care costs in the United States and elsewhere around the world continue to rise, individuals seeking medical treatment are frequently subjected to stress, not only over their immediate medical problems, but also regarding the payment for medical services to treat those very problems. Particularly for individuals that are uninsured, underinsured, or self-insured, the high cost of medical treatment can be a significant hardship. Even for those patients fortunate enough to have a medical care plan or medical insurance plan, cost is still a common concern since many plans require the patient to pay substantial sums of money in the form of high deductibles before the carrier will begin payment on medical bills. Oftentimes, the more affordable a plan is to an individual, the higher the deductible that must be paid.

Compounding these issues is the lack of any price transparency for medical care made available to the general public. Unlike many other service professions which outline, in detail, the cost associated with the services up-front, medical care is often provided without an itemized cost estimate provided to the patient. Many times, only insurance companies or other health care plans, such as Medicaid or Medicare, have access to the prices of such services. Patients, therefore, have no idea how much a medical procedure will cost when agreeing to it or even when having the service performed. The expense is typically only known once the patient receives the bill or insurance payment statement, sometimes several months after the procedure has been completed, and the cost is often at prices several times higher than usual reimbursements by third party payers to those same providers. Such is the case even for non-emergency medical procedures. The current system deters patients from seeking out desired care from a variety of potential hospitals, outpatient diagnostic/treatment facilities, or medical personnel. Indeed, many individuals or outpatient diagnostic/treatment facilities are not even aware that medical procedure prices are negotiable or that they can vary wildly even between hospitals that are located in close geographic proximity. This lack of published pricing and the availability of discounts discourages competition between providers, to the detriment of the patients.

Thus, a method or system of providing consumers with the ability to more effectively or efficiently shop for preferred health care is desired. The method or system would desirably allow potential patients access to prices and costs associated with various procedures to allow those patients to make informed decisions about their health care issues before undergoing a particular procedure. Moreover, the method or system would desirably allow users to conveniently determine information according to their own subjective desires and to easily navigate such information. In addition, the method or system would desirably allow users the option of bundling medical procedures and/or ancillary services for lower pricing and/or more convenient shopping.

### SUMMARY

The present invention is related to a method and system for determining cost of desired medical procedures. In one embodiment, a system for determining a medical procedure for a user may include a memory configured to store data and a processor connected with the memory. The processor may be configured to determine a medical procedure, determine a geographic location for the medical procedure, determine a medical facility for the medical procedure at the geographic location, determine a medical practitioner, and determine a price for the medical procedure using the data stored in the memory.

In another embodiment, a method for providing pricing for medical procedures to a user may include providing a processor and a memory accessible by the processor, receiving, using the processor, user input from the user, determining, using the processor, a medical procedure based on the user input, determining, using the processor, a geographic location for the medical procedure based on the user input, determining, using the processor accessing the memory, a cost for the medical procedure in the geographic location, and displaying, using the processor, the cost to the user.

In still another embodiment, a method for providing bundled pricing for medical procedures to a user may include providing a processor and a memory coupled with the processor, determining, using the processor, a medical procedure desired by the user, determining, based on data stored in the memory, a predetermined bundle package having a bundle cost, the bundle package including the medical procedure, displaying, using the processor, the bundle package and the bundle cost to the user, and receiving scheduling information from the user to schedule the medical procedure to be performed for the user.

### BRIEF DESCRIPTION OF THE DRAWINGS

The features, objects, and advantages of the present invention will become more apparent from the detailed description set forth below when taken in conjunction with the drawings, wherein:

FIG. 1 shows a block diagram of a system implementing a price transparency medical procedure search according to one embodiment of the present invention;

FIG. 2 shows a flowchart of a method for implementing a price transparency medical procedure search according to one embodiment of the present invention;

FIG. 3 shows a display to a user for a query, the display a part of a system implementing a price transparency medical procedure search according to one embodiment of the present invention;

FIG. 4 shows a display to a user with results of a query, the display a part of a system implementing a price transparency medical procedure search according to one embodiment of the present invention;

FIG. 5 shows a flowchart of a method for implementing bundled pricing in a system implementing a price transparency medical procedure search according to one embodiment of the present invention; and

FIG. 6 shows a display to a user with results of a query and the option of bundled packages, the display a part of a system implementing a price transparency medical procedure search according to one embodiment of the present invention.

### DETAILED DESCRIPTION

The detailed description of exemplary embodiments herein makes reference to the accompanying drawings and pictures, which show the exemplary embodiment by way of illustration and its best mode. While these exemplary embodiments are described in sufficient detail to enable those skilled in the art to practice the invention, it should be understood that other embodiments may be realized and that logical and mechanical changes may be made without departing from the spirit and scope of the invention. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

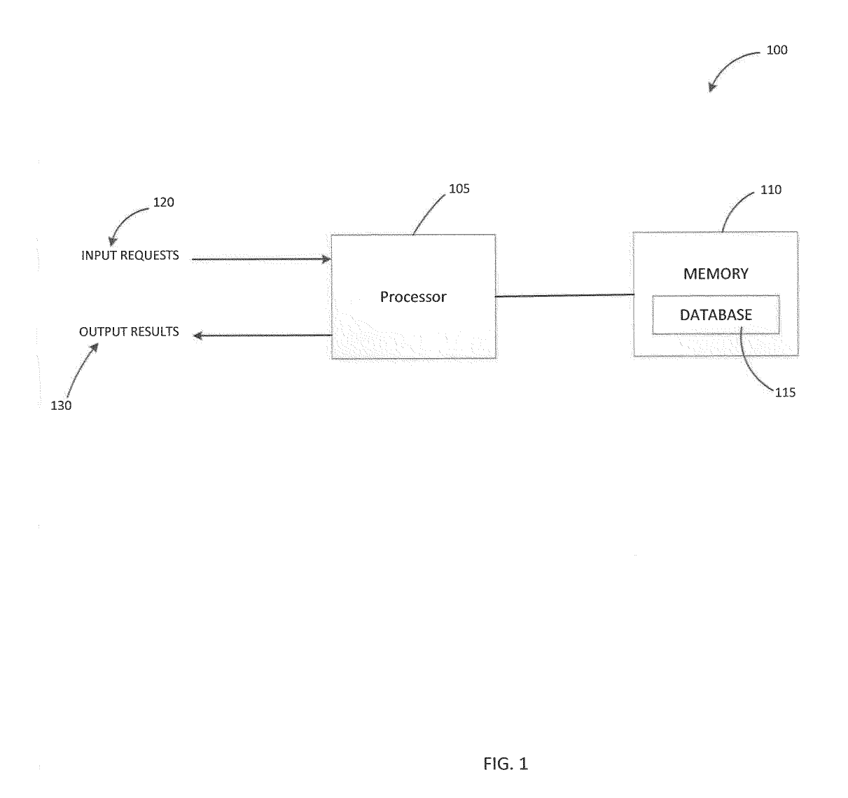

Turning first to FIG. 1, a block diagram of a system 100 implementing a price transparency medical procedure search is shown. The system 100 includes a processor 105 connected with a memory 110, the memory 110 configured to store data. The processor is configured to interface or otherwise communicate with the memory, for example, via electrical signals propagated along a conductive trace or wire. In an alternative embodiment, the processor 105 may interface with the memory 110 via a wireless connection. In a preferred embodiment, the memory 110 may include a database 115, a plurality of data or entries stored in the database 115 of the memory 110.

As discussed in greater detail herein, the processor 105 may be tasked with executing software or other logical instructions in order for the price transparency medical procedure search to function as desired. Input requests 120 may be received by the processor 105 (e.g., via signals transmitted from a user at a remote system or device, such as a handheld device like a smartphone or tablet, to the processor 105 via a network or Internet connection). In an alternative embodiment, the input requests 120 may be received by the processor via a user input device that is not at a geographically remote location (e.g., via a connected keyboard, mouse, etc. at a local computer terminal). After performing tasks or instructions based upon the user input requests 120, for example, looking up information or data stored in the memory 110, the processor 105 may output results 130 back to the user that are based upon the input requests 120.

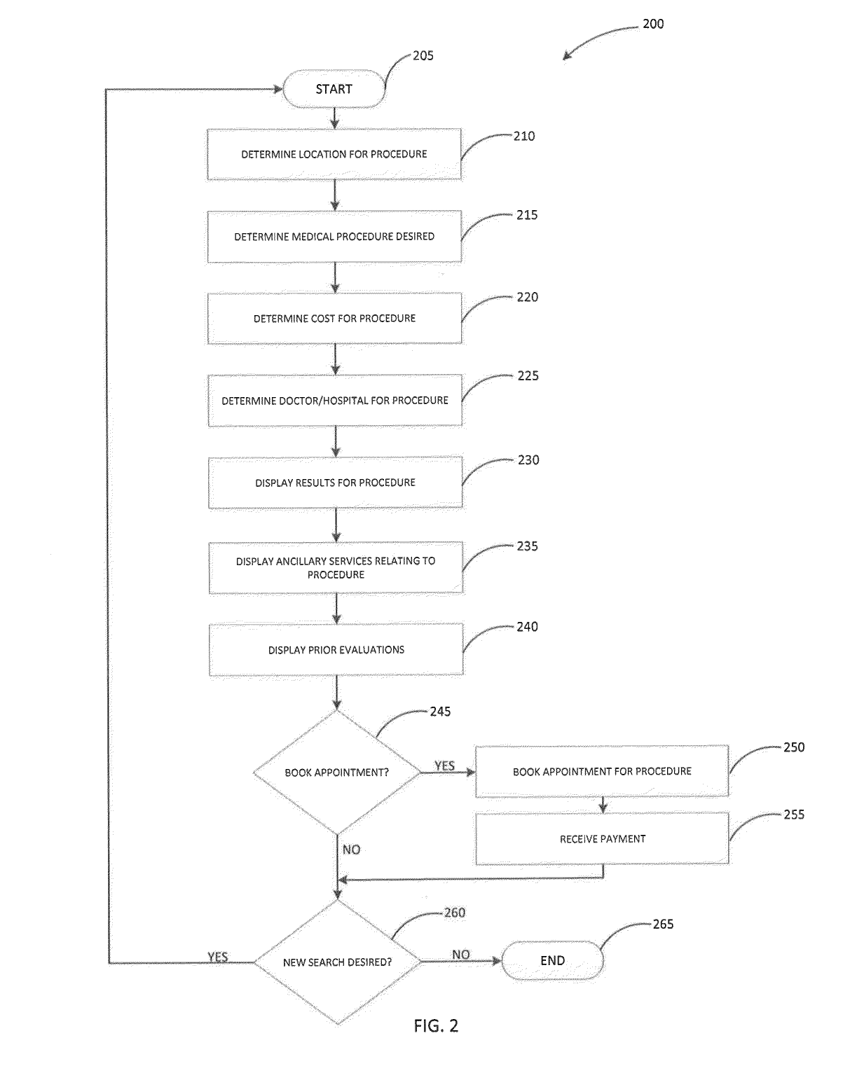

Turning next to FIG. 2, a flowchart of a process or method 200 for implementing a price transparency medical procedure search is shown. The process 200 may be implemented in a system that utilizes a processor for evaluating software instructions or code and a memory interfacing with the processor. For example, a system the same as or similar to that described by FIG. 1 may be used in one embodiment. Thus, in a preferred embodiment, a webpage may be established that allows a user to interact with various interactive elements or controls (e.g., drop-down boxes, checkboxes, radio buttons, text boxes, buttons, etc.) in order to determine a desired medical procedure for the user, as discussed in greater detail below. At step 205, the process starts. In one example, this may occur when a user clicks on a link to arrive at or otherwise enters a webpage URL into an Internet browser on their personal computer, tablet, smartphone, etc. Other embodiments may utilize alternative ways for allowing user interaction besides a webpage (e.g., a computer software executable, such as a smartphone or tablet application, etc.)

At step 210, the processor determines a location or geographic area for a medical procedure that is desired by the user. This may be determined by examining input from the user that is received via one or more interactive elements or controls placed on a webpage. For example, a dropdown box or a textbox may be disposed on the webpage and ask for the user to indicate, by selecting or typing, respectively, the geographic area where they would like to have a medical procedure performed. The interactive elements may function by asking the user to indicate a city, state, zip code, address, or the like and may also indicate a desired radius (for example, in miles) that represents the maximum geographic distance from the indicated address that the user would be willing to travel for performance of the medical procedure. In some embodiments, a map may be displayed on the webpage to allow the user to graphically pinpoint the address and desired radius upon the graphical map. Certain embodiments may allow a user to search in a variety of different countries (e.g., United States, Europe, Canada, etc.) or worldwide.

At step 215, the processor determines a type of medical procedure that is desired by the user. Similar to step 210, this may be determined by examining input from the user that is received via one or more interactive elements or controls placed on a webpage. For example, a dropdown box or a textbox may be disposed on the webpage and ask for the user to indicate, by selecting or typing, respectively, the type of medical procedure they are interested in having performed. Medical procedures of various fields may be determinable, for example, out-patient surgery, GI Labs, LASIK, dental implants, Medi-Spa, etc.

At step 220, a cost for the desired medical procedure in the location or geographic area is determined by the processor. For example, the processor may interface with a memory that contains a database of locations (e.g., hospitals, physician, or other clinics) that are capable of performing the desired medical procedure. Price data may be stored in the database or obtainable by connecting to other databases or servers, the price data being associated with each of those locations for the desired medical procedure. Thus, based on the determination of a desired medical procedure and a desired location for the procedure in steps 215 and 210, respectively, pricing data may be obtained.

The cost or pricing for the procedure may be on an all-inclusive basis (e.g., include both facility fees and professional fees). Traditional medical services do not publish costs to cash paying patients or clients that do not utilize an insurance carrier for substantial portions of the bill. Using the described process, price discovery or transparency for medical products or services may be provided to customers where it was traditionally not available. In certain embodiments, additional search criteria related to cost may be available as part of the system, for example, the form of payment that may be used for paying for the procedure or service. Indeed, any of a variety of search criteria may be used in alternative embodiments, in addition to or alternative to those previously described, for example, price, payment type, geographic location, proximity to related facilities (e.g., rehabilitation centers, etc.), doctor experience, hospital familiarity with the procedure, teaching hospital proximity, etc.

At step 225, the processor determines hospitals or doctors within the desired area or location that are available to perform the medical procedure desired. This may include hospitals, care facilities, and/or doctors that have signed up with the system of search described by FIG. 2. For example, membership fees may be paid by such hospitals, care facilities, and/or doctors that wish to be searchable by users utilizing the system. In an alternative embodiment, all hospitals, care facilities, and/or doctors may be included in the search whether or not they have agreed to participate in the system.

At step 230, the results of the determinations made by the processor in steps 210, 215, 220, and/or 225 for the medical procedure are displayed to the user. The display of the results may be a single location and cost for the medical procedure desired or may be a list of possible locations and corresponding prices that the user may choose amongst. In this manner, the user may browse the list for deciding the best location and/or cost for having the medical procedure performed. The results may all be displayed at once to the user or may be displayed across various screens or tabs that require the user to click or otherwise manipulate a control on a webpage to see additional results. The results may be organized for display according to various schemes (e.g., from lowest price to highest price, from closest location to furthest location, etc.). In certain embodiments, the user may choose or manipulate how the results are organized for display. In another embodiment, pricing may be determined in step 220 for locations outside of the location determined in step 210 and the user may be prompted as to whether they would desire to see additional results that extend beyond the location previously determined.

At step 235, ancillary services relating to the medical procedure are displayed to the user. For example, a medical procedure that would require lengthy patient care after surgery, such as physical training to re-learn muscle movements, may display memberships to nearby physical training centers that the patient can choose to add to the price of the medical procedure. Any of a variety of ancillary services may be displayed that would be relevant to the user considering the medical procedure. The display of these ancillary services may be on the same page or screen as the results displayed according to step 230, or may be segregated onto a separate link, page or screen for the user to browse if desired. Providers of such ancillary services may sign up with the system with pricing at a discounted rate. In this fashion, both the operator of the system benefits (in the form of a greater number of providers offering services at low prices) and the providers themselves benefit (in the form of increased exposure to potential customers using the system).

At step 240, one or more prior evaluations for the medical procedure (at the location determined in step 210 and/or the hospital or doctor in step 225 and/or in general) are displayed to the user. If multiple locations, hospitals, or doctors are displayed to the user in step 230, prior evaluations may be shown to the user, if existing, for each of the display results. These prior evaluations may, in one embodiment, be aggregated, user-submitted evaluations from prior patients that had the medical procedures performed at those locations, hospitals, or doctors. Similar to the discussion above for step 230, the order or organization of the prior evaluations may initially be determined by the processor (e.g., newest evaluations first), but may be modified by the user to have a different organization if desired (e.g., most critical evaluations first). In certain embodiments, users may be able to rate prior evaluations, such as by clicking a link indicating that a particular evaluation was helpful to read. In such embodiments, users may be able to sort or modify the evaluations according to most helpful to least helpful.

In one embodiment, the prior evaluations may be reviews, data, qualifications, and/or statistics according to other sources, such as the number of times a doctor has performed a particular medical procedure, the number of patients a hospital treats in a year, where a particular doctor went to medical school, etc. Any of a variety of different information can be shown to the user for the purposes of providing transparent data about the individuals or facilities involved in the performance of the medical procedure to aid the user in choosing their preferred doctor or hospital. For example, one user may be more concerned about price over any other aspect, while another user may be willing to pay a higher price for a doctor with greater experience in performing the type of medical procedure of interest.

In certain embodiments, the reviews, data qualifications, and/or statistics as mentioned above may be used in order to determine which search results and/or in which order those results will be displayed to the user in step 230. For example, prompts, queries, or other controls that allow for user manipulation may allow a user to receive information or results more suited to that user's particular interests for aiding in making an informed choice. For example, a user may choose to only see results for doctors above a certain experience level (e.g., number of years practicing, number of procedures performed, etc.) even if such results yield higher costs than would otherwise be displayed. In another example, a user may desire to browse the lowest costs for a medical procedure, but only for those procedures using a doctor above a certain experience level. Similarly, a user may desire to browse the lowest costs for a medical procedure, but only for those procedures at a hospital that have a particular number of those same procedures performed within over a particular period of time. Any of a number of search criteria can be included such that the user can decide which search criteria to limit the search according to those aspects which are most important to them.

At step 245 it is determined whether the user wishes to book an appointment for one of the results displayed in step 230. This may occur, for example, in response to the user selecting one of the results displayed and clicking on a link indicating a desire to schedule the medical procedure per the selected result. If an appointment is desired, operation continues to step 250. If no appointment is desired, operation continues to step 260, discussed in greater detail below. At step 250, available times and/or dates for the medical procedure at the selected result may be displayed for the user to browse and choose a desired appointment time. In some embodiments, the user may be able to select a desired span of dates or times and the processor will determine and/or cause to display available appointment times within that span. At step 255 the processor may receive payment information (e.g., a credit card number, a PayPal account, a deposit account number, etc.) from the user to pay for all or a portion of the medical procedure. In some embodiments, no payment may be required.

Operation then continues to step 260 to determine whether a new medical procedure search is desired. This may occur, for example, in response to user input indicating they wish to modify a current or already existing search that they have performed or whether they wish to begin a new search from the beginning. If no new search is desired, operation continues to step 265 where the process ends. However, if a new search is desired, operation continues back to step 205 where the process starts anew. Alternative embodiments may utilize additional or fewer steps than those explicitly shown in the exemplary flowchart of FIG. 2. Certain steps may be combined. Steps may additionally or alternative be performed in a differing order from those explicitly shown.

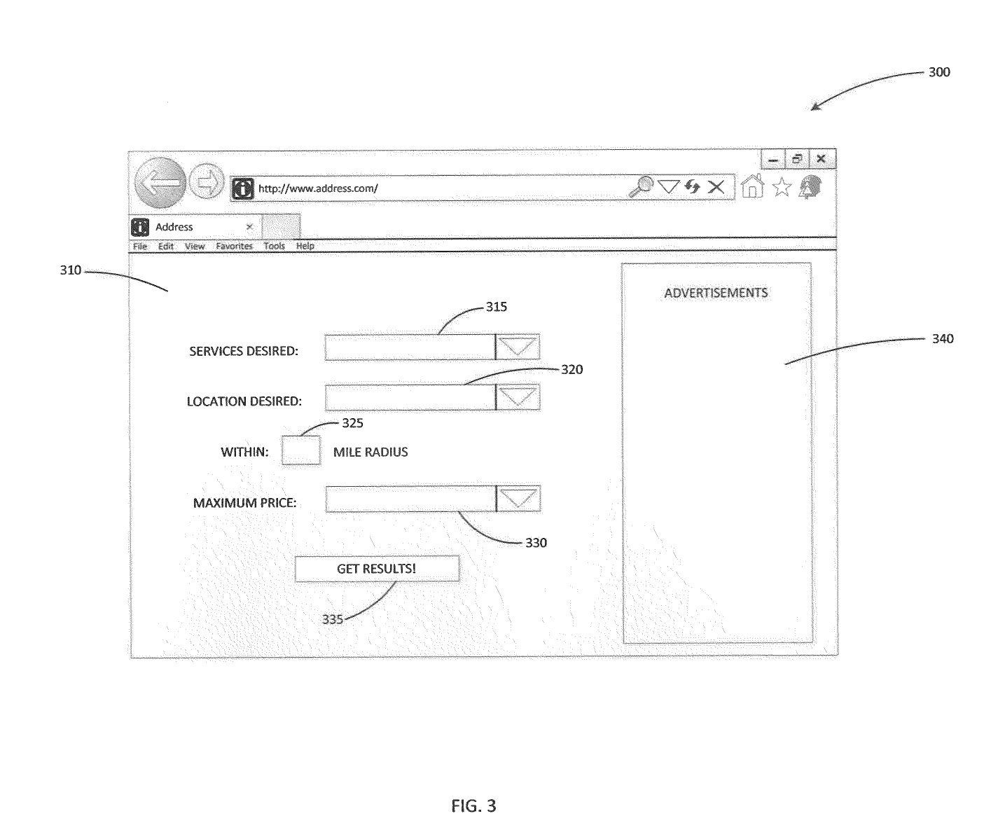

FIG. 3 shows a display 300 that may be presented to a user for a query, the display 300 a part of a system implementing a price transparency medical procedure search. The system may include features that are the same as or similar to those previously discussed. For example, the display 300 may be part of a system that allows a user to search for information regarding a desired medical procedure, such as previously discussed for FIGS. 1 and 2. As illustrated, the display 300 may be a webpage that is accessed using a standard browser (e.g., Internet Explorer, Google Chrome, Mozilla Firefox, etc.) and includes content 310 that is displayed in the browser.

The display 300, according to the exemplary embodiment shown in FIG. 3, includes a first dropdown box 315 that allows a viewer of the display 300 to choose a desired medical service or procedure from a pre-generated list. In an alternative embodiment, other forms of controls or elements in place of or in addition to the first dropdown box 315, or any of the other controls or elements discussed herein, may be used for allowing a user to indicate a desired medical service or procedure. Similarly, the display 300 includes a second dropdown box 320 that allows the viewer of the display 300 to choose a desired location for the medical service or procedure to be performed from a pre-generated list. A textbox 325 allows the viewer to further indicate a desired distance from the chosen location that would be desirable. Like discussed above, in an alternative embodiment, other forms of controls or elements in place of or in addition to the second dropdown box 320 and/or the textbox 325 may be used for allowing a user to indicate a desired location.

The display 300 also includes a third dropdown box 330 that allows a viewer of the display 300 to choose a maximum price the viewer would be willing to pay for performance of the medical service or procedure at the location indicated. In an alternative embodiment, other forms of controls or elements in place of or in addition to the third dropdown box 330 may be used for allowing a user to indicate their maximum desired price. A button 335 may be clicked by the viewer upon selection or entering of information according to elements 315, 320, 325, and/or 330 to send the selected information to a processor or other component of the system. In certain embodiments, not all of the information shown in FIG. 3 need be submitted or entered before choosing to run a search for results. This information may then be used for determining search results for subsequent display to the viewer, for example, as discussed in greater detail in FIGS. 1 and/or 2.

Advertisements 340 may be shown on the display 300 for providing a source of revenue for the system implementing the display 300. The revenue from advertisements 340 may be the only form of revenue for the system or other streams may be received in conjunction with or in replacement of advertisements 340 in alternative embodiments. For example, participating facilities that perform the medical procedures that are capable of being searched (e.g., hospitals, surgery centers/providers, etc.) may pay an initial membership fee and/or an ongoing monthly maintenance fee to be included as part of the system. In still another example, a participating facility may additionally or alternatively pay a search fee or a click-through fee when a medical procedure is performed due to a searched or scheduled appointment from using the system implementing the display 300. In one embodiment, the viewer of the display 300 or user of the system is not charged any fee for use of the system. Alternative embodiments may utilize subscription plans or other monetary compensation from the users.

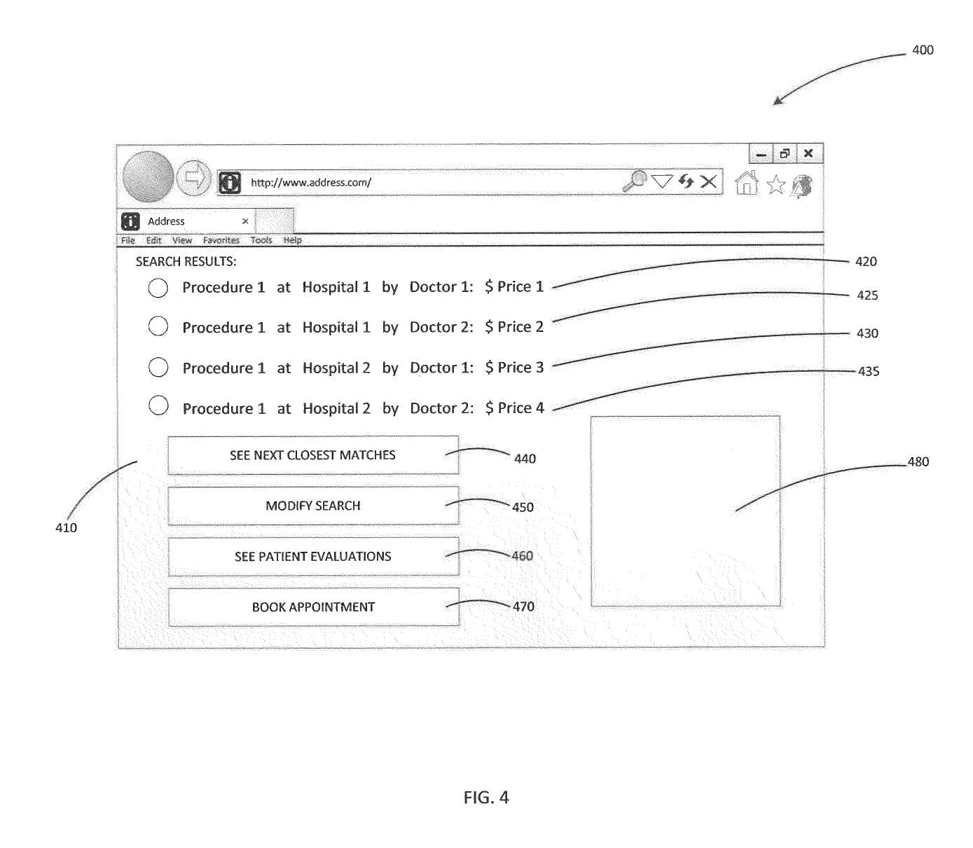

FIG. 4 shows a display 400 to a user with results of a query, the display 400 a part of a system implementing a price transparency medical procedure search. The system may include features that are the same as or similar to those previously discussed. For example, the display 400 may be part of a system that allows a user to search for information regarding a desired medical procedure, such as previously discussed for FIGS. 1, 2, and/or 3. As illustrated, the display 400 may be a webpage that is accessed using a standard browser (e.g., Internet Explorer, Google Chrome, Mozilla Firefox, etc.) and includes content 410 that is displayed in the browser.

The display 400, according to the exemplary embodiment shown in FIG. 4, includes a plurality of search results (420, 425, 430, 435). These search results (420, 425, 430, 435) may be the result of a processor receiving user input data from a user or viewer of the system implementing the display 400 and using the data to search in a database or other memory for obtaining price or cost information, for example as discussed above in FIGS. 1, 2, and/or 3. For example, as illustrated, if a user of the system indicated a desired medical procedure (i.e., “Procedure 1” and indicated a desired location (i.e., such location encompassing “Hospital 1” and “Hospital 2” within its borders, with “Doctor 1” and “Doctor 2” in such area and available to perform particular medical procedure), those four search results (420, 425, 430, 435) and their associated costs (i.e., “Price 1,” “Price 2,” “Price 3,” and “Price 4,” respectively) are shown. If additional search results exist based on the desired medical procedure and location, the user of the system may click a button 440 to receive additional results. In an alternative embodiment, greater or fewer numbers of search results may be displayed to a user in any of a variety of possible formats (e.g., displayed one per page, displayed per location, etc.).

If the user wishes to modify the search in some fashion, the button 450 may be pressed. This may present a query screen (e.g., display 300 of FIG. 3) to the user. If the user wishes to see patient evaluations, for example, user evaluations, reviews, data, qualifications, and/or statistics, the same as or similar to those previously discussed, button 460 may be pressed. The search results (420, 425, 430, 435) may be presented as radio buttons such that the user can click to select one or more of the search results (420, 425, 430, 435) and then press the button 460 to get more detailed information that is relevant to the selected search result. Likewise, if a particular search result is desirable to a user, the user may click to select such search result and then press a button 470 allowing them to book or schedule an appointment for the medical procedure. Similar to FIG. 3, advertisements 480 may be provided on the display 400 for providing a source of revenue for the system implementing the display 400.

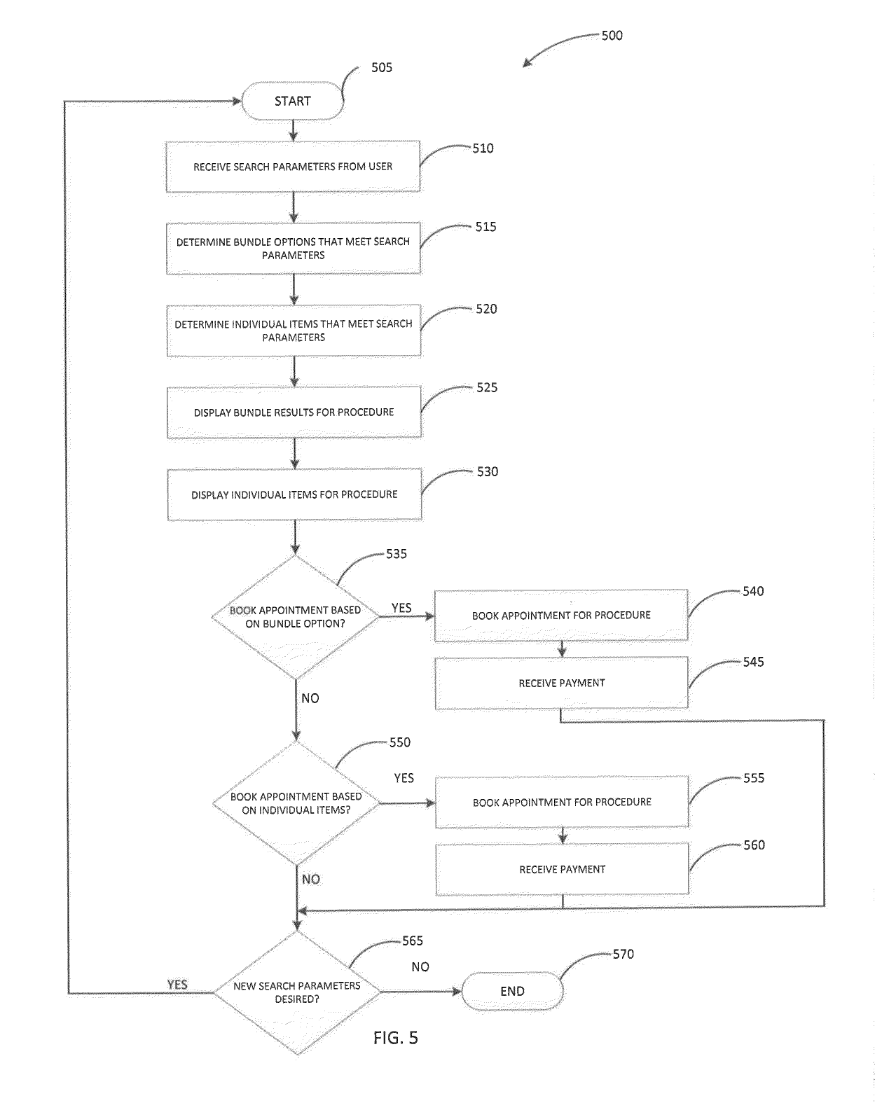

Turning next to FIG. 5, a flowchart of a process or method 500 for implementing a price transparency medical procedure search with bundling is shown. The process or method may include features that are the same as or similar to those previously discussed. In FIG. 5, a selection of predetermined bundle packages are determined for the user and displayed to the user for selection, as discussed in greater detail herein. The process or method 500 may be implemented in a system that utilizes a processor for evaluating software instructions or code and a memory interfacing with the processor. For example, a system the same as or similar to those previously described may be used in one embodiment. Thus, in a preferred embodiment, a webpage may be established that allows a user to interact with various interactive elements or controls (e.g., drop-down boxes, checkboxes, radio buttons, text boxes, buttons, etc.) in order to determine a desired medical procedure for the user, as discussed in greater detail below. At step 505, the process starts. In one example, this may occur when a user clicks on a link to arrive at or otherwise enters a webpage URL into an Internet browser on their personal computer, tablet, smartphone, etc.

At step 510, the processor receives search parameters from the user. This may occur by allowing the user to type, click, or otherwise select among different criteria (e.g., medical procedures, surgeries, medical services, date/time, geographic location, hospital, doctor, etc.) in order to determine the interests of the user. This may be determined by examining input from the user that is received via one or more interactive elements or controls placed on a webpage. For example, a dropdown box or a textbox may be disposed on the webpage and ask for the user to indicate, by selecting or typing, respectively, the geographic area where they would like to have a medical procedure performed. The interactive elements or controls may be located upon a single webpage screen or may span a plurality of webpage screens which a user clicks through and makes selections thereon.

The same as or similar to the previous discussions, the interactive elements may function by asking the user to indicate a city, state, zip code, address, or the like and may also indicate a desired radius (for example, in miles) that represents the maximum geographic distance from the indicated address that the user would be willing to travel for performance of the medical procedure. In some embodiments, a map may be displayed on the webpage to allow the user to graphically pinpoint the address and desired radius upon the graphical map. Certain embodiments may allow a user to search in a variety of different countries (e.g., United States, Europe, Canada, etc.) or worldwide.

At step 515, the processor determines one or more bundle options or packages that meet one or more of the search parameters received in step 510. The bundle options or packages may represent groups or collections of medical procedures/services and/or other types of services or items that are combined together into one selectable package by the user. A bundle cost or price for each of the bundle options or packages is also determined. In a preferred embodiment, the bundle cost is a lower cost than if the user had opted to individually select each of the medical procedures/services and/or other types of services or items that are combined together to form the bundle. For example, this lower cost may be obtained by having predetermined contracts or agreements with particular vendors of goods or services, where they agree to offer such goods or services at a lower price in order to be included in the bundle packaging. In one embodiment, only bundle options or packages that meet all of the user-desired search parameters in step 510 are determined for selection. In an alternative embodiment, bundle packages may be determined for selection by the user if they meet only some of the search parameters in step 510, but not all of them.

At step 520, the processor determines individual items that may be selected by the user for purchase that meet one or more of the search parameters received in step 510. A corresponding cost for each of the individual items is also determined. Similar to previous discussions, price data for a variety of medical procedures, services, and/or ancillary goods or services may be stored in a database or otherwise obtainable by connection to a remote system or server and obtained when the search parameters received in step 510 indicates such medical procedures, services, and/or ancillary goods or services meet the user's desires.

At step 525, the results of the determination made by the processor in step 515 are displayed to the user. The display of the results may be a single bundle package with a corresponding bundle cost that was determined to meet the user's search parameters from step 510 or may be a list of bundle packages with corresponding bundle prices. In this manner, the user may browse the list for deciding the bundle package according to their preferences. The results may all be displayed at once to the user or may be displayed across various screens or tabs that require the user to click or otherwise manipulate a control on a webpage to see additional results. The results may be organized for display according to various schemes (e.g., from lowest price to highest price, from closest geographic location to furthest geographic location, etc.). In certain embodiments, the user may manipulate how the results are organized for display.

Similarly, at step 530, the results of the determination made by the processor in step 520 are displayed to the user. The display of the results includes each of the individual procedures, services, and/or items and a corresponding cost or price for each individual procedure, service, and/or item that were determined in step 520 to match the user's search parameters in step 510. In this manner, if the user would rather choose specific options, rather than the, perhaps more limited, options available in the bundle packages, the user is free to select according to those precise desires. For example, while the bundle results displayed in step 525 may only correspond to particular hospitals, doctors, etc. that have agreed to offer their goods or services for a reduced cost as part of bundle deals, if the user desires a specific hospital or doctor not among the bundled options, the user may choose according to those preferences via the procedures, services, and/or items.

In one embodiment, the cost to the user for making individual selections may be greater than if the same selections were chosen as part of a bundled package. The same as or similar to the previous discussion, the results may all be displayed at once to the user or may be displayed across various screens or tabs that require the user to click or otherwise manipulate a control on a webpage to see additional results. The results may be organized for display according to various schemes (e.g., from lowest price to highest price, from closest geographic location to furthest geographic location, etc.). In certain embodiments, the user may manipulate how the results are organized for display.

At step 535 it is determined whether the user wishes to book an appointment for one of the bundle package options displayed in step 525. This may occur, for example, in response to the user selecting one of the bundle options displayed and clicking on a link indicating a desire to schedule an appointment per the selected result. If an appointment is desired, operation continues to step 540. If no appointment is desired, operation continues to step 550, discussed in greater detail below. At step 540, available times and/or dates for the medical procedure at the selected result may be displayed for the user to browse and choose a desired appointment time. In some embodiments, the user may be able to select a desired span of dates or times and the processor will determine and/or cause to display available appointment times within that span. In other embodiments, the bundle package may be only for a predetermined date. At step 545 the processor may receive payment information (e.g., a credit card number, a PayPal account, a deposit account number, etc.) from the user to pay for all or a portion of the bundle package option. In some embodiments, no payment may be required. Operation then continues to step 565, as discussed in greater detail below.

At step 550, it is determined whether the user wishes to book an appointment for one or more individual items displayed in step 530. This may occur, for example, in response to the user selecting one or more of the individual items displayed and clicking on a link indicating a desire to schedule an appointment or to purchase the selected result. If an appointment or purchase is desired, operation continues to step 555. If no appointment or purchase is desired, operation continues to step 565, discussed in greater detail below. At step 555, available times and/or dates, if applicable, or other purchase input information as desired for the one or more individual items may be displayed for the user to browse and provide additional information as needed. At step 560, similar to the discussion above, the processor may receive payment information (e.g., a credit card number, a PayPal account, a deposit account number, etc.) from the user to pay for all or a portion of the individual items that were selected. In some embodiments, no payment may be required.

Operation then continues to step 565 to determine whether new (e.g., modified) search parameters are desired by the user. This may occur, for example, in response to user input indicating they wish to modify a current or already existing search that they have performed or whether they wish to begin a new search from the beginning. If no new search parameters are desired, operation continues to step 570 where the process ends. However, if new search parameters are desired, operation continues back to step 505 where the process starts anew. Alternative embodiments may utilize additional or fewer steps than those explicitly shown in the exemplary flowchart of FIG. 5. Certain steps may be combined. Steps may additionally or alternative be performed in a differing order from those explicitly shown.

Any of a variety of search parameters may be used for generating search results for a user, either for bundle package options and/or for individual item options. For example, a user may desire to browse bundle package options that are available that include a particular doctor, surgeon, or other medical practitioner at a particular hospital or other medical facility. In this manner, the user may obtain an inexpensive and comprehensive price by browsing and selecting a bundle package option, but still maintain control over the medical personnel and/or facilities performing or involved in the procedure. If a user is instead more interested in price and/or location, and less interested in the medical practitioner and/or facility, those alternative search parameters may be entered by the user and used for determining the search results. By allowing the user flexibility to enter as many or as few search parameters as they desire, more customized search results may be obtained for the user to select amongst.

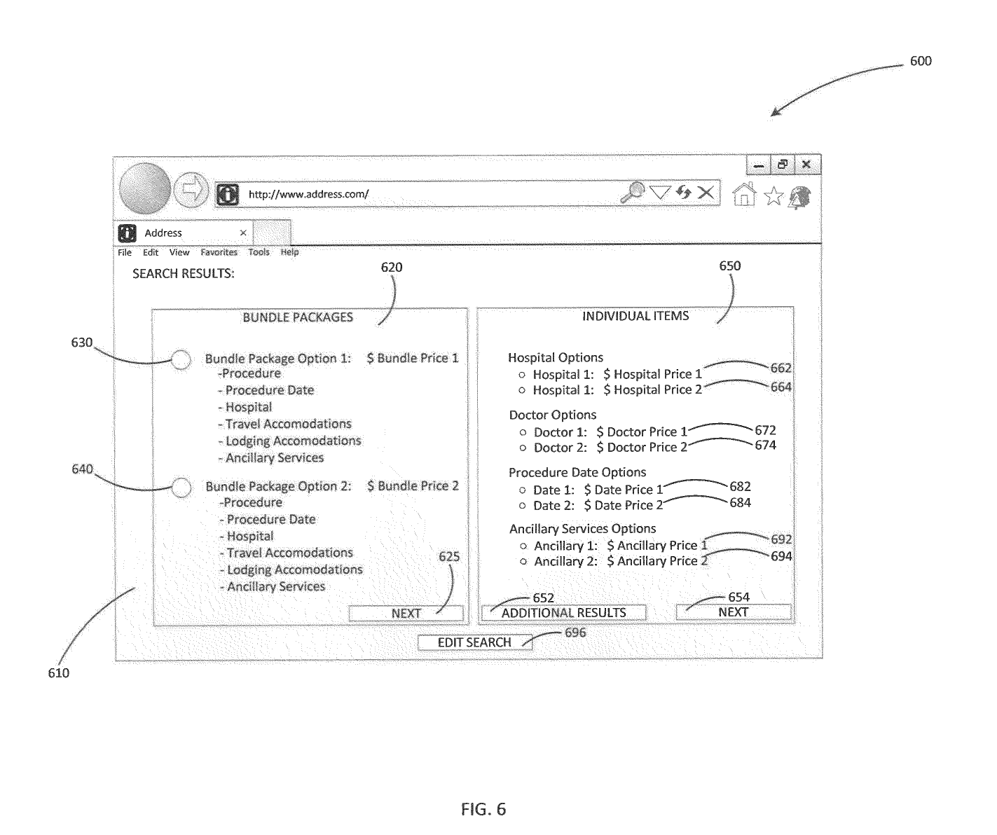

FIG. 6 shows a display 600 to a user with results of a query, the display 600 a part of a system implementing a price transparency medical procedure search with bundling. The system may include features that are the same as or similar to those previously discussed. For example, the display 600 may be part of a system that allows a user to search for information regarding a desired medical procedure, such as previously discussed. As illustrated, the display 600 may be a webpage that is accessed using a standard browser (e.g., Internet Explorer, Google Chrome, Mozilla Firefox, etc.) and includes content 610 that is displayed in the browser.

The system uses search parameters received from the user in order to determine bundle options and/or individual items to offer for sale to the user, the same as or similar to the previous discussions. After making such determinations, the system showcases such results to the user upon a display screen where the user is able to make selections according to their preferences. The display 600, according to an exemplary embodiment illustrated in FIG. 6, includes bundle package options 620 and individual (e.g., a la carte) item options 650 that may be selected by the user for purchase. Regarding the bundle package options 620, a first bundle package option 630 and a second bundle package option 640 are shown and selectable by the user (e.g., by clicking on a radio button, checkbox, or other interactive element that is displayed on the display 600). In an alternative embodiment, greater or fewer bundle package options may be displayed to the user for selection.

The first bundle package option 630 has a corresponding bundle cost or price that represents the cost to the user for all of the goods or services provided as part of the first bundle package option 630. For example, these goods or services may include some or all of the following: a medical procedure to be performed, the date and/or time of the performance of the medical procedure, hospital costs (e.g., room and board, meals, etc.) associated with the performance of the medical procedure, travel accommodations (e.g., airfare, bus fare, train fees, taxi costs, shuttle costs, etc.) in order to locate the user desiring the medical procedure from their residence to the hospital, lodging accommodations (e.g., hotel costs, after-care facilities, etc.) if the user will be away from their residence before and/or after the medical procedure is performed, and other, ancillary services (e.g., after-care treatment such as rehabilitation, etc.).

Similarly, the second bundle package option 640 has a corresponding bundle cost or price that represents the cost to the user for all of the goods or services provided as part of the second bundle package option 640. The goods or services offered as part of the second bundle package option 640 may be the same as or similar to those offered by the first bundle package option 630, as discussed above. For example, the same goods or services may be offered in both of the first bundle package option 630 and the second bundle package option 640, but at different hospital locations and/or at different dates or times. Such differences may result in different associated costs or prices for each of the first bundle package option 630 and the second bundle package option 640. In certain embodiments, the costs associated with the first bundle package option 630 and the second bundle package option 640 may be the same.

By comparing the costs and/or the goods or services offered by the first bundle package option 630 and the second bundle package option 640, the user may decide which bundle is more desirable and opt to select one of the bundles in order to book an appointment for the medical procedure and/or purchase the goods or services being offered. As previously discussed, the system implementing a price transparency medical procedure search with bundling may have contracts, agreements, or other arrangements with various vendors and/or providers of goods or services that have agreed to participate in bundling of their goods or services in exchange for offering such goods or services at a reduced price. For example, a vendor or provider may feel the increased quantity of goods or services sold as a result of bundled participation warrants a reduction in price in order to obtain those sales. In one embodiment and as shown, upon selecting the first bundle package option 630 or the second bundle package option 640, the user may click or select a next button 625 that continues system operation to a booking, reservation, or other purchase setup, for example, as previously discussed.

In order to accommodate users who do not wish to purchase bundle packages (e.g., users with particular preferences for doctors, hospitals, travel arrangements, etc.) the system also allows users to specifically chose individual items that represent goods and/or services based upon the search parameters received from the user. For example, if the user indicated via the search parameters that they currently resided in California and desired Lasik surgery, bundle options may be shown for particular hospitals and/or doctors in the nearby geographic area that have agreed to participate in bundling of goods and/or services, but the user may have a particular hospital or doctor that they wish to see or the user may not need or may desire to make their own travel accommodations. Rather than only being able to choose a bundled option, such a user can instead more specifically choose the individual components of or relating to the desired procedure.

The display 600 shows to the user the individual item options 650 that may be selected by the user for purchase. The same as or similar to previous discussions, these individual item options 650 may be based upon search parameters previously received from the user. For example, a first hospital option 662 with a corresponding first hospital price, a second hospital option 664 with a corresponding second hospital price, a first doctor option 672 with a corresponding first doctor price, and a second doctor option 674 with a corresponding second doctor price may be shown. The user may then specifically choose the hospital and the doctor for the procedure. In addition, a first date option 682 with a corresponding first date price and a second date option 684 with a corresponding second date price may be shown. The user is thus permitted to choose a specific date and/or time for the desired procedure to be performed.

A first ancillary option 692 with a corresponding first ancillary price and a second ancillary option 694 with a corresponding second ancillary price are also displayed, allowing users to choose between and/or to choose more than one ancillary service that is related to the desired procedure (e.g., aftercare services, medications purchases, medical equipment purchases, etc.). One or more of the individual item options 650, are selectable by the user (e.g., by clicking on a radio button, checkbox, or other interactive element that is displayed on the display 600). In an alternative embodiment, greater or fewer individual item options may be displayed to the user for selection.

By comparing the costs and/or the goods or services offered by the various individual item options 650, the user may decide which items are desirable and opt to select one or more of the individual items for purchase. In one embodiment and as shown, upon selecting one or more of the individual item options 650, the user may click or select a next button 654 that continues system operation to a booking, reservation, or other purchase setup, for example as previously discussed. If more individual items are available and offered to the user than may be displayed at once on the display 600, the user may click or select an additional results button 652 in order to view a next page or listing of individual item options 650 that may be purchased. If the user decides that either or both of the bundle packages 620 and/or the individual item options 650 do not correspond to their desires, an edit search 696 button may be clicked or selected in order to re-enter or modify some or all of the search parameters.

The previous description of the disclosed examples is provided to enable any person of ordinary skill in the art to make or use the disclosed methods and apparatus. Various modifications to these examples will be readily apparent to those skilled in the art, and the principles defined herein may be applied to other examples without departing from the spirit or scope of the disclosed method and apparatus. The described embodiments are to be considered in all respects only as illustrative and not restrictive and the scope of the invention is, therefore, indicated by the appended claims rather than by the foregoing description. All changes which come within the meaning and range of equivalency of the claims are to be embraced within their scope. Skilled artisans may implement the described functionality in varying ways for each particular application, but such implementation decisions should not be interpreted as causing a departure from the scope of the disclosed apparatus and methods. The steps of the method or algorithm may also be performed in an alternate order from those provided in the examples.

What is claimed is:

1. A system for determining a medical procedure for a user comprising:
a memory configured to store data; and
a processor connected with the memory and configured to:
determine a medical procedure,
determine a geographic location for the medical procedure,
determine a medical facility for the medical procedure at the geographic location,
determine a medical practitioner, and
determine a price for the medical procedure using the data stored in the memory.

2. The system of claim 1 wherein the processor is configured to determine the medical procedure from user input generated via a query screen displayed to the user.

3. The system of claim 2 wherein the query screen is a webpage configured to be accessed by the user via the Internet.

4. The system of claim 3 wherein the webpage contains advertisements thereon.

5. The system of claim 3 wherein the user input is generated by the user manipulating a control on the query screen displayed to the user.

6. The system of claim 3 wherein the processor is configured to determine the geographic location from a second user generated by the user manipulating a second control on the query screen displayed to the user.

7. The system of claim 2 wherein the processor is further configured to display a result to the user after receiving the user input from the user.

8. A method for providing pricing for medical procedures to a user, the method comprising:
providing a processor and a memory accessible by the processor;
receiving, using the processor, user input from the user;
determining, using the processor, a medical procedure based on the user input;
determining, using the processor, a geographic location for the medical procedure based on the user input;
determining, using the processor accessing the memory, a cost for the medical procedure in the geographic location; and
displaying, using the processor, the cost to the user.

9. The method of claim 8 further comprising determining, using the processor, a facility located within the geographic location for performance of the medical procedure.

10. The method of claim 8 further comprising displaying, using the processor, an ancillary service associated with the medical procedure to the user.

11. The method of claim 8 further comprising displaying, using the processor, a prior evaluation of the medical procedure by a prior user.

12. The method of claim 11 wherein the prior evaluation is a submission of a prior user, stored in the memory.

13. The method of claim 8 further comprising the step of scheduling, using the processor, the medical procedure at the geographic location for the user.

14. The method of claim 13 further comprising the step of receiving payment information from the user for the scheduling of the medical procedure at the geographic location for the user.

15. A method for providing bundled pricing for medical procedures to a user, the method comprising:
providing a processor and a memory coupled with the processor;
determining, using the processor, a medical procedure desired by the user;
determining, based on data stored in the memory, a predetermined bundle package having a bundle cost, the bundle package including the medical procedure;
displaying, using the processor, the bundle package and the bundle cost to the user; and
receiving scheduling information from the user to schedule the medical procedure to be performed for the user.

16. The method of claim 15 wherein the bundle package includes travel services.

17. The method of claim 16 wherein the bundle package includes lodging services.

18. The method of claim 15 wherein the bundle cost of the bundle package is lower than a cost corresponding to the sum of individual costs for each service included in the bundle package.

19. The method of claim 15 wherein the step of determining a medical procedure desired by the user is based upon user input received from the user via the Internet.

20. The method of claim 19 further comprising the step of providing a software application configured to be executed on a handheld device, the software application configured to interface with the processor over the Internet for sending the user input to the processor.
